(19) United States
(12) Patent Application Publication
(10) Pub. No.: US 2007/0118510 A1
(43) Pub. Date: May 24, 2007

(54) Optimization of leaf-level multi-dimensional calculation using scripts

(75) Inventors: Baomin Li, Renton, WA (US); Peiyuan Yan, Redmond, WA (US); Xiaohong Yang, Sammamish, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/283,194

(22) Filed: Nov. 18, 2005

(51) Int. Cl. G06F 17/30

(52) U.S. Cl. 707/3

(57) ABSTRACT

Leaf-level, multi-dimensional calculations are optimized by translating the multi-dimensional calculations to efficient query scripts. To generate efficient query scripts, rows are transposed to columns while affected rows are reduced by reversing calculation relationships. Actual calculations are performed on calculated columns. Transposing row-to-column enables fast arithmetic calculations. Reversing the calculation relationships enables a reduction of the rows that need to be processed.

### BACKGROUND

Financial data is often viewed in the form of a spreadsheet containing rows and columns of figures, or data. Such spreadsheets are commonly implemented on computers, so that changes to one item may be automatically reflected in any other items, which use the altered item as a basis for a calculation. Before any such manipulation of data can occur, however, the data must be imported from storage or input by the user. Many companies and individuals now routinely enter their basic financial data into computers for such later retrieval and manipulation.

Leaf-level multi-dimensional calculation often is the bottleneck for applications dealing with large amounts of data and contributes to significant performance degradation in relational server analysis. The performance degradation is mainly caused by search space explosion and an inherent complexity of algorithmically reducing the scope. A simple calculation may result in significant adverse performance impact of a query script or in exceeding internal space restriction for the query.

### SUMMARY

Leaf-level, multi-dimensional calculation is optimized by translating the multi-dimensional calculation to a query script. The query script transposes rows into columns while reducing a number of affected rows by reversing calculation relationships. Actual calculations are then performed on calculated columns, which are generated by the query script.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 illustrates a computing device in which a calculation application for leaf-level multi-dimensional calculations may be implemented;

FIG. 2 illustrates an example system, where aspects of a leaf-level multi-dimensional calculation application may be implemented;

FIG. 3 is a conceptual diagram illustrating major functional blocks involved in a leaf-level multi-dimensional calculation;

FIG. 4 is a conceptual diagram illustrating an example transposition and reduction of rows prior to actual calculation a leaf-level multi-dimensional calculation;

FIG. 5 illustrates an example of a leaf-level, multi-dimensional calculation with transposition and reduction of rows based on an example pseudo script;

FIG. 6 illustrates a logic flow diagram for a process of determining leaf-level multi-dimensional calculation rules; and

FIG. 7 illustrates a logic flow diagram for a process of a leaf-level multi-dimensional calculation with transposition and reduction of rows using query scripts.

### DETAILED DESCRIPTION

Embodiments of the present disclosure now will be described more fully hereinafter with reference to the accompanying drawings, which form a part hereof, and which show, by way of illustration, specific exemplary embodiments for practicing the invention. This disclosure may, however, be embodied in many different forms and should not be construed as limited to the embodiments set forth herein; rather, these embodiments are provided so that this disclosure will be thorough and complete, and will fully convey the scope to those skilled in the art. Among other things, the present disclosure may be embodied as methods or devices. Accordingly, the present disclosure may take the form of an entirely hardware embodiment, an entirely software embodiment or an embodiment combining software and hardware aspects. The following detailed description is, therefore, not to be taken in a limiting sense.

Illustrative Operating Environment

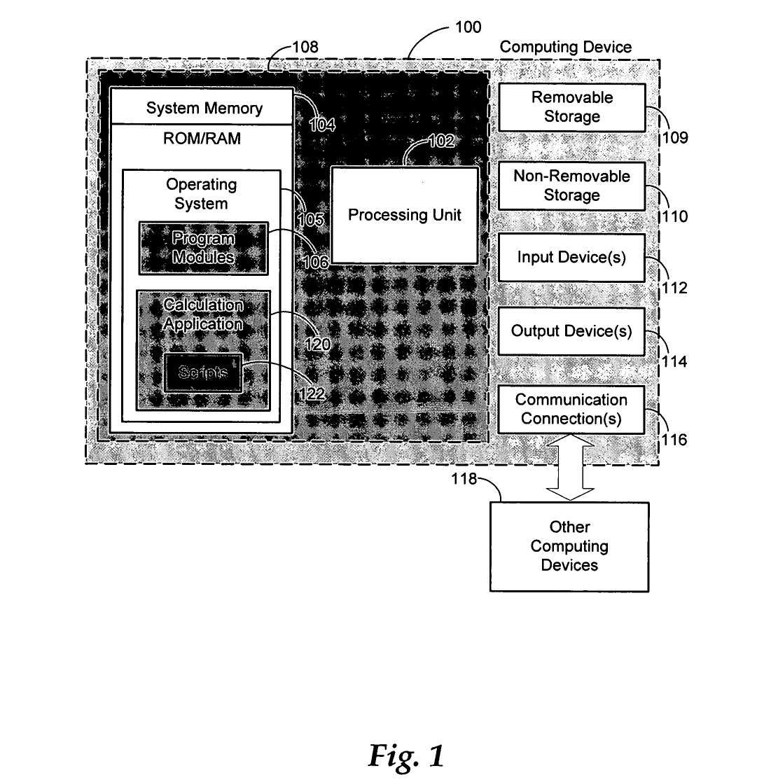

Referring to FIG. 1, an exemplary system for implementing some embodiments includes a computing device, such as computing device 100. In a very basic configuration, computing device 100 typically includes at least one processing unit 102 and system memory 104. Depending on the exact configuration and type of computing device, system memory 104 may be volatile (such as RAM), non-volatile (such as ROM, flash memory, etc.) or some combination of the two. System memory 104 typically includes operating system 105 and one or more program modules 106 working within operating system 105.

In addition to program modules 106, calculation application 120 may also be executed within operating system 105. Calculation application 120 may be a business application performing calculations on multi-dimensional data to analyze and report on status, goals, progress, financial analysis, and the like. To optimize leaf-level multi-dimensional calculations, calculation application 120 may translate the calculation relationship(s) to a query script (122) that transposes rows into columns and reduces a number of affected rows for efficient resource utilization.

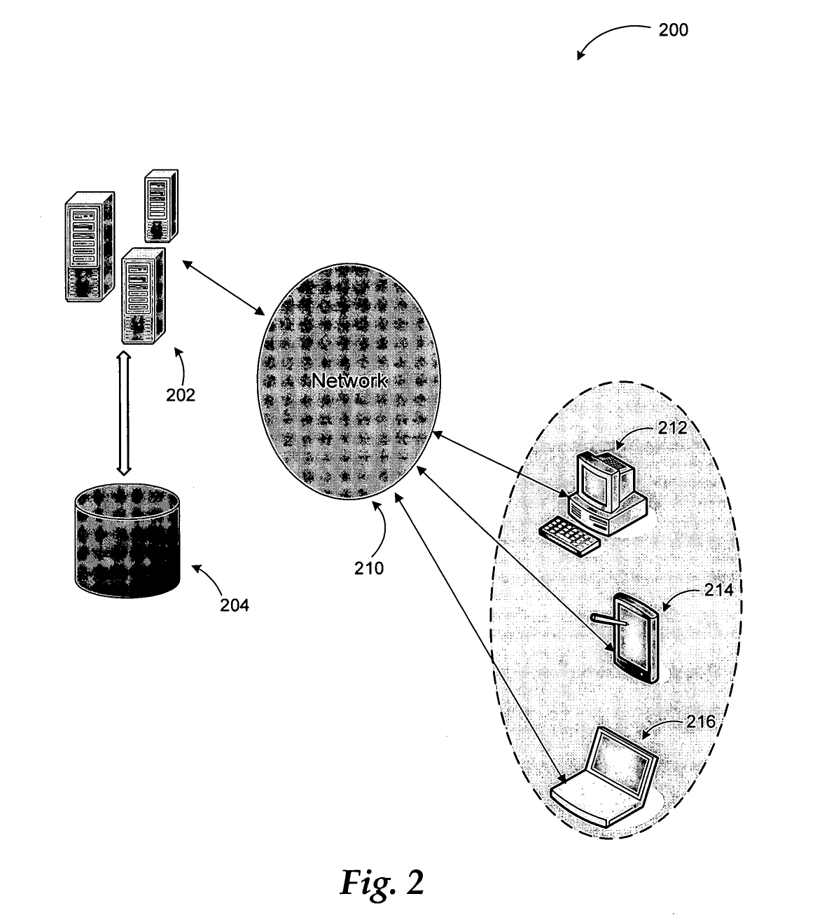

To perform the actions described above, calculation application 120 may include and/or interact with other computing devices and applications and application interfaces (APIs) residing in other applications such as the database shown in FIG. 2.

Computing device 100 may have additional features or functionality. For example, computing device 100 may also include additional data storage devices (removable and/or non-removable) such as, for example, magnetic disks, optical disks, or tape. Such additional storage is illustrated in FIG. 1 by removable storage 109 and non-removable storage 110. Computer storage media may include volatile and nonvolatile, removable and non-removable media implemented in any method or technology for storage of information, such as computer readable instructions, data structures, program modules, or other data.

System memory 104, removable storage 109 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 100. Any such computer storage media may be part of device 100. Computing device 100 may also have input device(s) 112 such as retail devices, keyboard, mouse, pen, voice input device, touch input device, etc. Output device(s) 114 such as a display, speakers, printer, etc. may also be included.

Computing device 100 also contains communication connections 116 that allow the device to communicate with other computing devices 118, such as over a network. Communication connections 116 are one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

FIG. 2 illustrates an example system, where aspects of a leaf-level multi-dimensional calculation application may be implemented. System 200 may include one or more networks that comprise any topology of servers, clients, Internet service providers, and communication media. The networks may also have a static or dynamic topology.

A calculation application, such as calculation application 120 of FIG. 1, may reside on server(s) 202. In one embodiment, the application may be run across distributed servers, mainframe computers, and the like. Server(s) 202 may include a number of other applications such as accounting applications, database applications, communication applications, and the like.

In another embodiment, server(s) 202 may interact with database 204 that is arranged to store data for business applications. The calculation application may translate leaf-level calculations to a query script before performing the actual calculations reducing a number of operations and utilized resources such as memory significantly.

The calculation application may interact with client devices, such as handheld computer 214, desktop computer 212, and laptop computer 216, over network 210 to receive instructions such as the relationship for the calculation, provide reports, and perform other calculation related tasks. Client devices communicating with server(s) 202 may include any type of computing device, not limited to the examples shown herein. In one embodiment, the calculation application may be implemented in one of the client devices and interact with database 204 through server(s) 202.

Network 210 may be a secure network such an enterprise network, or an unsecure network such as a wireless open network. Network 210 provides communication between the nodes described above. By way of example, and not limitation, network 210 may include wired media such as a wired network or direct-wired connection, and wireless media such as acoustic, RF, infrared and other wireless media.

Many other configurations of computing devices, communications, applications, and distribution systems may be employed to implement a multi-dimensional calculation application that uses query scripts to optimize leaf-level calculations.

Illustrative Embodiments For Optimization Of Leaf-Level Multi-Dimensional Calculations Using Query Scripts

Embodiments are directed to optimizing leaf-level multi-dimensional calculations by translating the multi-dimensional calculations to efficient query scripts. Databases store leaf-level information in rows. For calculation operations, each row has to be drawn completely leading to large numbers of memory operations in sparse data environments. On the other hand, columns provide an efficient calculation mechanism. In column format, only the rows containing data of interest are drawn for calculation.

Compared to brute force multi-dimensional expression scripts, translated scripts utilizing transposed rows may perform faster by order of magnitudes. To generate efficient query scripts, rows are transposed to columns while affected rows are reduced by reversing calculation relationships. Transposing row-to-column enables fast arithmetic calculations. Reversing the calculation relationships enables a reduction of the rows that need to be processed.

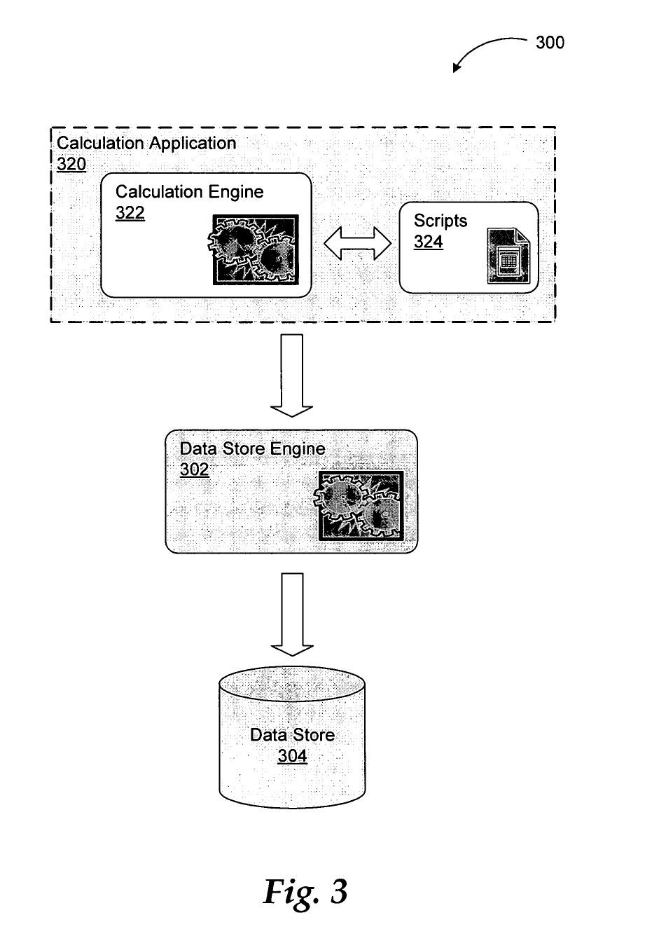

FIG. 3 is a conceptual diagram illustrating major functional blocks involved in a leaf-level multi-dimensional calculation. Diagram 300 shows calculation application 320 including calculation engine 322 and scripts 324, data store engine 302, and data store 304.

Calculation application 320 is arranged to perform calculations on leaf-level, multi-dimensional data based on user defined or selected rules. Calculation application 320 may interact with one or more user interfaces, modeling applications, and the like to receive the calculation rules and user requests to perform the calculation.

In one embodiment, calculation engine 322 translates calculation rules to a query script that is arranged to transpose rows to columns while selecting affected rows by reversing calculation relationships. The query scripts may be in Multi-Dimensional expression (MDX) syntax, Sequential Query Language (SQL) syntax, and the like. The calculation relationship may be based on a single rule or a rule set. Calculation engine 322 may generate one or more query scripts based on the calculation relationship. Once a query script is generated, it may be executed by the calculation engine, stored in volatile or non-volatile memory for later execution, etc.

When calculation engine 322 executes the query script(s), rows are transposed selectively and calculated columns generated based on individual terms of the calculation relationship. Data store engine 302 is arranged to apply operators of the calculation relationship to the calculated columns for the actual calculation rendering the result values based on the specified relationship. Data store engine 302 may be part of a separate application such as a server analysis application or part of calculation application 320.

Source data for performing the above described operations, such as transposition, selection of rows, generation of calculated columns, and actual calculation, as well as transposed column table and results may be stored in data store 304.

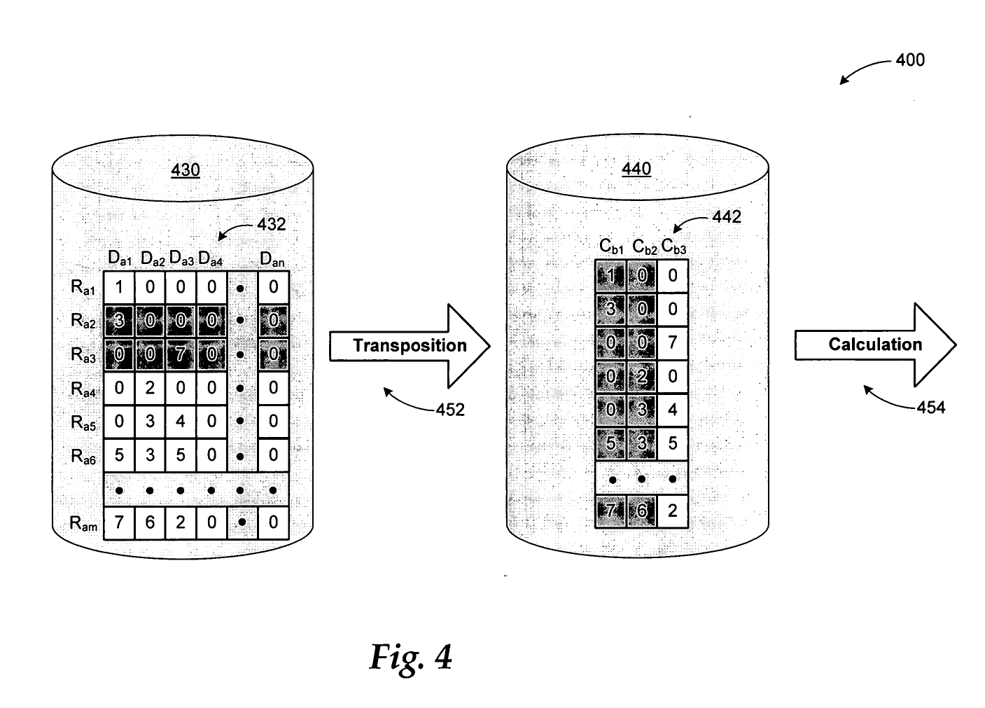

FIG. 4 is a conceptual diagram illustrating an example transposition and reduction of rows prior to actual calculation a leaf-level multi-dimensional calculation.

According to one embodiment, rows are transposed into columns and calculated columns are used to perform actual calculation. Traditional inner join approach may not perform well because large number of rows in the fact table may result in increased resource usage and system slow down. By transposing the rows, multiple join conditions are reduced to a one-pass aggregation, thus resulting in significantly increased performance gain. While transposing the rows into columns, the number of the affect rows is reduced using reverse relationships to further decrease the rows that need to be calculated.

Diagram 400 shows example data table 432 in data store 430. Data table 432 includes n dimensions, Dₐₗ through Dₐₙ and m rows, Rₐₗ through Rₐₘ. Transposition operation 452, as described in more detail below, selects rows of interest (e.g. rows Rₐ₂ and Rₐ₃) using reverse relationship terms and transposes them into columns such that calculated columns can be generated corresponding to terms of the calculation relationship.

Example transposed table 442 in data store 440 includes transposed columns C_{b1}, C_{b}2, and C_{b3}. While C_{b1}, and C_{b2} correspond to the transposed rows, C_{b3} may be used as a calculated column for one of the terms in the calculation relationship. A transposed data table (structure) may include as many columns as necessary depending on the number of terms in the calculation relationship. The transposed table may further include an additional column for the result values. Once the rows are transposed and calculated columns generated, calculation 454 may be performed by a database engine to derive result values by applying the calculation operators to the individual term values. Data stores 430 and 440 may be the same data store or distinct data stores.

Other functional blocks, data structures, and operations may be implemented using the principles described herein.

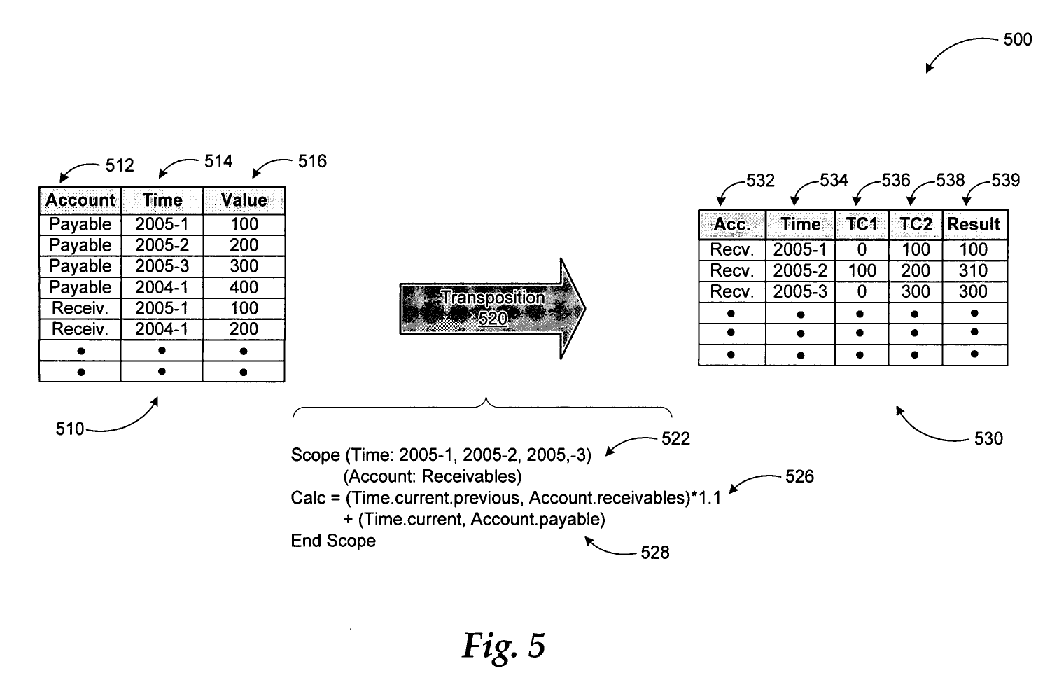

FIG. 5 illustrates an example of a leaf-level, multi-dimensional calculation with transposition and reduction of rows based on an example pseudo script.

Diagram 500 includes example data on which the calculation is to be performed in table 510. Column 512 of table 510 is the “Account” dimension of the data. The “Account” dimension includes two members: accounts payable and accounts receivable. Next dimension is “Time” in column 514 of table 510. “Time” dimension includes members: 2004-1, 2005-1, 2005-2, and 2005-3. The digits after the dash refer to months of each year. Finally, column 516 includes values corresponding to the listed account types in the listed time period.

The example calculation relationship is based on the rule that a value for an accounts receivable member is to be calculated based on multiplying the accounts receivable value of the previous time period with 1.1 and adding the accounts payable value for the current time period.

The relationship is expressed in form of a pseudo script as shown in the figure. The pseudo script includes scope 522, which includes for “Time” dimension members 2005-1, 2005-2, and 2005-3; and for “Account” dimension the receivables member.

The calculation relationship is stated in multi-dimensional expression syntax. First term 526 in the relationship is formed by multiplying a value determined from a member (TC1) corresponding to an intersection of a previous “Time” member with receivables member of “Account” dimension. First term 526 is used to form first calculated column 536 in transposed data table 530. Second term 528 is formed by an intersection of a current “Time” dimension member and a payable member of the “Account” dimension. Second term 528 is used to form second calculated column 538 in transposed data table 530.

Transposition 520 is the process where rows are transposed into columns while only affected rows are selected such that calculated columns corresponding to terms in the relationship are generated. Transposed data table 530 is obtained as a result of transposition 520 by the calculation engine.

Transposed data table 530 includes first column 532 listing members of the “Account” dimension within the scope defined for the calculation. Second column 534 includes members of the “Time” dimension within the defined scope. Third column 536 (TC1) and fourth column 538 (TC2) include calculated values corresponding to each term in the calculation relationship. Thus, a reverse relationship method is used in generating third column 536 (TC1) and fourth column 538 (TC2). Fifth column 539 (Result) lists calculated values of the complete calculation. Fifth column 539 is generated by the database engine applying the operations defined by the calculation to the terms listed in third column 536 (TC1) and fourth column 538 (TC2).

For example, to determine third column 536 value for accounts receivable in 2005-1, a value of accounts receivable for the previous time period is drawn. Since no value for 2004-12 exists, TC1 has a “0” value for this term. Fourth column 538 for accounts receivable in 2005-1 is determined from a current time period value of accounts payable. In this case, the value is “100” from table 510. Once TC1 and TC2 are determined, the calculated columns can be used to determine the result by multiplying TC1 value with 1.1 (still “0”) and adding TC2 value. This operation renders the result value in first row of fifth column 539 as “100”.

For the second example, first term TC1 is calculated from previous time period value of accounts receivable again. Because the current time period is 2005-2 in this case, TC1 is “100” from fifth row of table 510. TC2 value is determined from current value of accounts payable, which is “200”. Performing the actual calculation on the calculated column values TC1 and TC2, the result value “310” is obtained.

It should be noted that during the transposition and reduction of the rows, a hierarchy within the data structure is preserved.

Other data structures, data types, hierarchies, naming conventions, and the like may be implemented using the principles described herein.

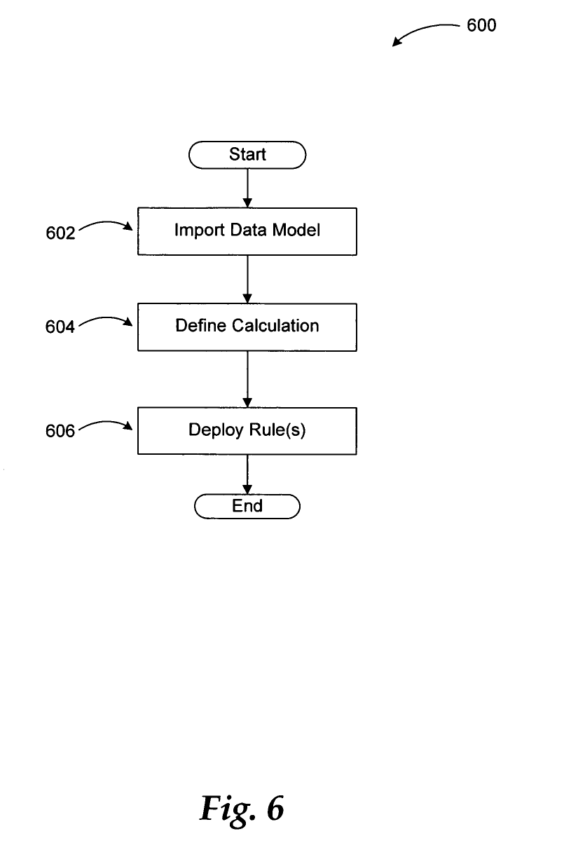

FIG. 6 illustrates a logic flow diagram for a process of determining leaf-level multi-dimensional calculation rules.

Process 600 is generally directed to determining and deploying rules for optimizing a leaf-level, multi-dimensional calculation by transposing rows into columns and reducing affected rows using reverse relationships before performing the actual calculation.

Process 600 begins at operation 602, where a calculation engine imports a data model. The data model may include calculation relationship(s), information about data structure, and the like. Processing proceeds from operation 602 to operation 604.

At operation 604, the calculation engine defines the calculation. One or more rules provided by a user may be parsed to generate a query script that defines the actions for efficient multi-dimensional calculation. Processing advances from operation 604 to operation 606.

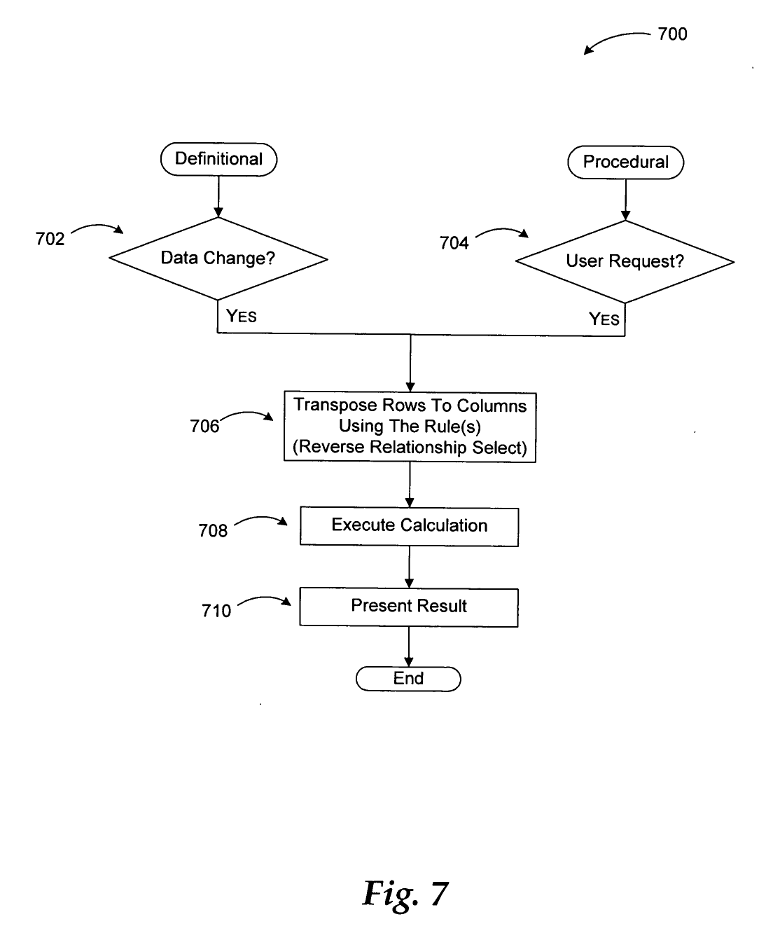

At operation 606, the rule(s) are deployed such that they can be used for performing the calculation based on a procedural method or a definitional method. Process 600 ends after the deployment of the rule(s), and may be followed by process 700 of FIG. 7 described below.

FIG. 7 illustrates a logic flow diagram for a process of a leaf-level multi-dimensional calculation with transposition and reduction of rows using query scripts.

Process 700 is directed to performing the leaf-level multi-dimensional calculation with transposition and reduction of rows using the rule(s) deployed in process 600 above. Process 700 may begin in a definitional system upon being triggered by a change to the data or in a procedural system upon being triggered by a user request.

In a definitional system, a determination is made, at decision operation 702, whether the data has been changed. For a definitional relationship, the rule is applied anytime the affected data is involved in an operation. The application of the rule is monitored by the system without a specific user request to perform the calculation based on the rule. If the determination is affirmative, processing moves to operation 706.

On the other hand, a specific user request is expected for executing the calculation for a procedural relationship. At decision operation 704, a determination is made whether such a user request is received. If the determination is affirmative, processing advances to operation 706.

At operation 706, select rows are transposed to columns based on the relationship specified by the calculation rule(s). The number of rows is thereby reduced using reverse relationship in selecting the rows to be transposed. In one embodiment, each transposed row generates a column for one of the calculation terms. For example, for a simple calculation expression of A=2*B+C, a column containing values for B and another column containing values for C may be generated by transposing the selected rows. Processing advances from operation 706 to operation 708.

At operation 708, the actual calculation is executed by a database engine. In the example above, the actual calculation corresponds to multiplying values of B with 2 and adding corresponding values of C to determine A. By limiting a number of operations to be performed by the database engine using the transposition and reduction of the rows, memory and processor resources are saved significantly resulting in increased performance. Processing moves from operation 708 to operation 710.

At operation 710, the results are presented to the user. Presentation of the results may include at least one of: providing result data to an application, storing the result data to the database, and the like. After operation 710, processing moves to a calling process for further actions.

The operations included in processes 600 and 700 are for illustration purposes. Optimizing leaf-level multi-dimensional calculations using query scripts may be implemented by a similar process with fewer or additional steps, as well as in different order of operations.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A computer-implemented method for performing a calculation on leaf-level, multi-dimensional data, comprising:
determining a calculation relationship based on at least one rule;
generating a query script based on the calculation relationship, wherein the query script is configured to perform actions including:
selecting at least one affected row of the data using a reverse relationship based on a portion of the calculation relationship;
transposing the at least one selected row into a column; and
generating at least one calculated column based on the portion of the calculation relationship;
executing the query script; and
performing an actual calculation using the at least one calculated column.

2. The computer-implemented method of claim 1, further comprising generating a results column based on the actual calculation.

3. The computer-implemented method of claim 1, wherein performing the actual calculation includes applying at least one operator of the calculation relationship to the at least one calculated column.

4. The computer-implemented method of claim 1, wherein the query script is executed automatically if the calculation is a definition.

5. The computer-implemented method of claim 1, wherein the query script is executed upon receiving a user request if the calculation is a procedure.

6. The computer-implemented method of claim 1, wherein the query script includes one of: a Multi-Dimensional expression (MDX) statement and a Sequential Query Language (SQL) statement.

7. The computer-implemented method of claim 1, further comprising receiving a data model, wherein the data model includes at least one of: the rule and information about a data structure.

8. The computer-implemented method of claim 7, wherein the data model is configured to receive the at least one rule from one of: a user interface and a database.

9. The computer-implemented method of claim 2, further comprising storing the results column.

10. The computer-implemented method of claim 1, further comprising storing the at least one transposed column and the at least one calculated column.

11. The computer-implemented method of claim 1, wherein selecting and transposing the at least one affected row preserves a hierarchy of the leaf-level, multi-dimensional data.

12. The computer-implemented method of claim 1, wherein the calculation is for at least one of: planning, budgeting, and forecasting a scenario in the business application.

13. The computer-implemented method of claim 1, wherein the leaf-level, multi-dimensional data is sparse data.

14. A computer-readable medium having computer instructions for performing a calculation on leaf-level, multi-dimensional data by translating rows to columns, the instructions comprising:
determining a calculation relationship based on a rule, wherein the rule is received from one of a user interface and a database;
selecting at least one affected row of the data using a reverse relationship based on a portion of the calculation relationship;
transposing the at least one selected row into a column; and
generating at least one calculated column based on the portion of the calculation relationship;
performing an actual calculation by applying at least one operator of the calculation relationship to the at least one calculated column; and
generating a results column based on the actual calculation.

15. The computer-readable medium of claim 14, wherein the instructions further comprise storing the at least one transposed column, the at least one calculated column, and the results column; and wherein the instructions conform to syntax of one of: a Multi-Dimensional eXpression (MDX) statement and a Sequential Query Language (SQL) statement.

16. A system for performing a calculation on leaf-level, multi-dimensional data using a query script, the system comprising:
a database configured to store a data to be used for the calculation;
an calculation engine configured to:
determine a calculation relationship based on at least one rule;
generate a query script based on the calculation relationship, wherein the query script is configured to perform actions including:
select at least one affected row of the data using a reverse relationship based on a portion of the calculation relationship;
transpose the at least one selected row into a column; and
generate at least one calculated column based on the portion of the calculation relationship; and
execute the query script; and
a database engine configured to:
perform an actual calculation by applying at least one operator of the calculation relationship to the at least one calculated column.

17. The system of claim 16, wherein the database engine is further configured to generate a results column based on the actual calculation.

18. The system of claim 16, wherein the database engine is further configured to store the at least one transposed column, the at least one calculated column, and the results column.

19. The system of claim 16, wherein the calculation engine is further configured to receive a data model from one of a user interface and the database, wherein the data model includes at least one of: the rule and information about a data structure.

20. The system of claim 16, wherein the calculation engine is further configured to dynamically modify the query script upon a change of one of: the rule and a portion of the data.
